(19) United States
(12) Patent Application Publication
(10) Pub. No.: US 2018/0105152 A1
(43) Pub. Date: Apr. 19, 2018

(54) LANE DEPARTURE SUPPRESSING APPARATUS

(71) Applicant: TOYOTA JIDOSHA KABUSHIKI KAISHA, Aichi-ken (JP)

(72) Inventors: Akira NAGAE, Susuno-shi (JP); Ryo INOMATA, Ashigarakami-gun (JP); Hironori ITO, Susono-shi (JP); Masayuki IKEDA, Susono-shi (JP)

(73) Assignee: TOYOTA JIDOSHA KABUSHIKI KAISHA, Aichi-ken (JP)

(21) Appl. No.: 15/681,952

(22) Filed: Aug. 21, 2017

(30) Foreign Application Priority Data
Oct. 19, 2016 (JP) 2016-205300

(51) Int. Cl. B60T 8/1755; G08G 1/16

(52) U.S. Cl. CPC B60T 8/17557; B60T 8/17551; G08G 1/167; B60T 2201/089; B60T 2201/083; B60T 2250/03; B60T 2201/081

(57) ABSTRACT

A lane departure suppressing apparatus is provided with: a supporter configured to perform departure suppression support for suppressing departure of a vehicle from a driving lane on which the vehicle is currently traveling; a detector configured to detect an adjacent area adjacent to the driving lane; a calculator configured to calculate an adjacent margin width, which is width of an area in which the vehicle can perform an avoidance action, out of the adjacent area; and a controller configured to control the supporter to increase intensity of the departure suppression support as the avoidance margin width becomes smaller.

### CROSS-REFERENCE TO RELATED APPLICATIONS

This application is based upon and claims the benefit of priority of the prior Japanese Patent Application No. 2016-205300, filed on Oct. 19, 2016, the entire contents of which are incorporated herein by reference.

### BACKGROUND OF THE INVENTION

### 1. Field of the Invention

Embodiments of the present invention relate to a lane departure suppressing apparatus configured to suppress departure of a vehicle from a driving lane on which the vehicle is currently traveling.

### 2. Description of the Related Art

For this type of apparatus, for example, there is known an apparatus configured to suppress lane departure by automatically adjusting behavior of a vehicle if there is a possibility that the vehicle departs or deviates from a driving lane. For example, in Japanese Patent No. 5350397, there is proposed a technique/technology in which it is determined whether or not the lane departure is allowed in accordance with a type of a lane mark for defining the driving lane and in which departure support control is performed in accordance with a determination result.

On the other hand, in Japanese Patent Application Laid Open No. 2008-012989, there is proposed a technique/technology regarding lane change control in which a control amount in a lateral direction of a vehicle is adjusted on the basis of a lane width and an offset amount from a lane.

In the aforementioned technique/technology disclosed in Japanese Patent No. 5350397, it is required to determine the type of the lane mark in performing the departure support control. During travel of the vehicle, however, there may be a situation in which the type of the lane mark cannot be accurately identified. In such a case, there is a possibility that the departure support control cannot be appropriately performed for the reason that the lane mark cannot be identified. Specifically, the control amount of the departure support control may be insufficient when the departure of the vehicle is to be avoided certainly. Alternatively, the control amount of the departure support control may be increased when the departure of the vehicle is to be allowed to some extent.

As described above, if the situation around the vehicle cannot be accurately determined, it is extremely hard to appropriately perform the departure support control. If the departure support control is not appropriately performed, discomfort may be given to an occupant of the vehicle and a risk of a collision with another vehicle or an obstacle may increase, which is technically problematic.

### SUMMARY

In view of the aforementioned problems, it is therefore an object of embodiments of the present invention to provide a lane departure suppressing apparatus configured to appropriately perform departure support control in accordance with the situation around the vehicle.

The above object of embodiments of the present invention can be achieved by a lane departure suppressing apparatus comprising: a supporter configured to perform departure suppression support for suppressing departure of a vehicle from a driving lane on which the vehicle is currently traveling; a detector configured to detect an adjacent area adjacent to the driving lane; a calculator configured to calculate an adjacent margin width, which is width of an area in which the vehicle can perform an avoidance action, out of the adjacent area; and a controller configured to control said supporter to increase intensity of the departure suppression support as the avoidance margin width becomes smaller.

According to the lane departure suppressing apparatus in embodiments of the present invention, if the calculated avoidance margin width is relatively small, adjustment is performed to relatively increase the intensity of the departure suppression support (in other words, to relatively increase a control amount by the departure suppression support). It is thus possible to certainly suppress the departure of the vehicle if the vehicle has a risk of collision. On the other hand, if the calculated avoidance margin width is relatively large, adjustment is performed to relatively reduce the intensity of the departure suppression support (in other words, to relatively reduce the control amount by the departure suppression support). It is thus possible to prevent excessive departure suppression support from being performed when the departure of the vehicle is not a big problem.

In one aspect of the lane departure suppressing apparatus according to embodiments of the present invention, wherein said calculator is configured to calculate a number of lanes that exist in the adjacent area, instead of the avoidance margin width, and said controller is configured to control said supporter to increase the intensity of the departure suppression support as the number of the lanes becomes smaller.

According to this aspect, the intensity of the departure suppression support is adjusted in accordance with the number of adjacent lanes. It is thus possible to easily determine the situation around the vehicle and perform the departure suppression support with appropriate intensity.

In another aspect of the lane departure suppressing apparatus according to embodiments of the present invention, wherein said calculator is configured to calculate an avoidance margin degree by dividing the avoidance margin width by a predetermined width, and said controller is configured to control said supporter to increase the intensity of the departure suppression support as the avoidance margin degree becomes smaller, instead of the avoidance margin width.

According to this aspect, the avoidance margin degree is calculated by dividing the calculated avoidance margin width by the predetermined width, one example of which is the width of a lane on which the vehicle can travel. If the intensity of the departure suppression support is adjusted in accordance with the avoidance margin degree, it is possible to more accurately determine the situation around the vehicle and perform the departure suppression support with appropriate intensity, in comparison with when the avoidance margin width is used as it is.

In another aspect of the lane departure suppressing apparatus according to embodiments of the present invention, wherein said supporter is configured to perform the departure suppression support (i) by calculating a suppression yaw moment, which allows the departure of the vehicle from the driving lane, and (ii) by applying braking force to wheels in such a manner that the calculated suppression yaw moment is applied to the vehicle, if there is a possibility that the vehicle departs from the driving lane.

According to this aspect, the departure from the driving lane can be suppressed by using a yaw moment generated by the application of the braking force to the vehicle.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram illustrating a configuration of a vehicle according to a first embodiment;

FIG. 2 is a top view illustrating one example of a vehicle that is traveling on a road and an avoidance margin area;

FIG. 3 is a top view illustrating one example of an avoidance action when there is an obstacle ahead of the vehicle;

FIG. 4 is a flowchart illustrating a flow of a lane departure suppressing operation according to the first embodiment;

FIG. 5 is a flowchart illustrating a flow of a process of setting control intensity K according to the first embodiment;

FIG. 6 is a map illustrating a relation between an avoidance margin width L and the control intensity K;

FIG. 7 is a flowchart illustrating a flow of a process of setting the control intensity K according to a second embodiment;

FIG. 8 is a map illustrating a relation between a number N of lanes and the control intensity K;

FIG. 9 is a top view illustrating one example of a vehicle that is traveling on a road and adjacent lanes; and

FIG. 10 is a flowchart illustrating a flow of a process of setting the control intensity K according to a third embodiment.

### DETAILED DESCRIPTION OF THE PREFERRED EMBODIMENTS

Hereinafter, lane departure suppressing apparatuses according to embodiments of the present invention will be explained with reference to the drawings. Hereinafter, a vehicle 1 equipped with the lane departure suppressing apparatuses according to embodiments of the present invention is used for explanation.

### First Embodiment

(1) Configuration of Vehicle 1

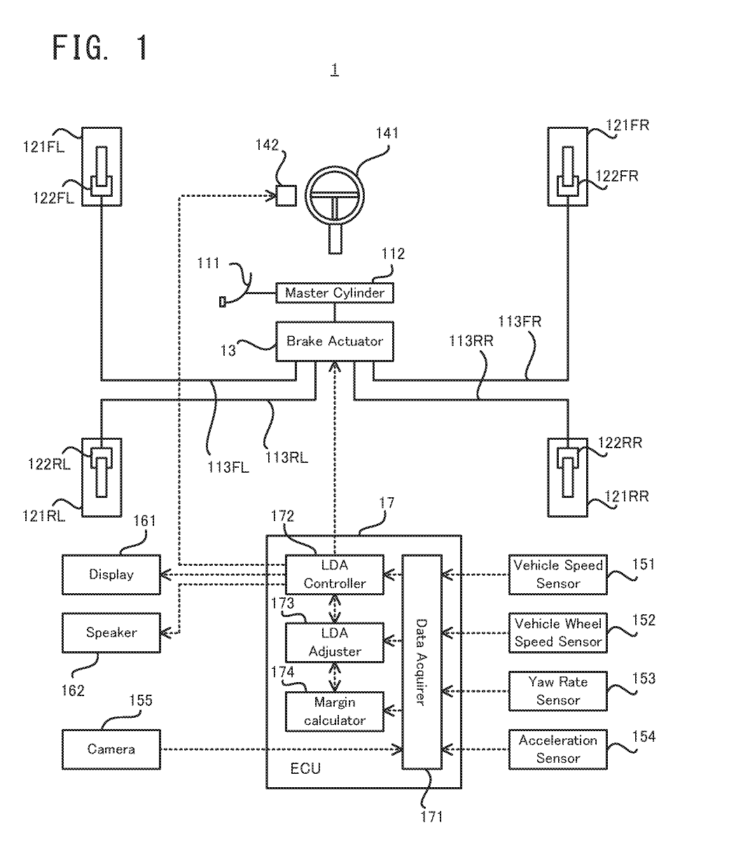

Firstly, a configuration of the vehicle 1 will be explained with reference to FIG. 1. FIG. 1 is a block diagram illustrating the configuration of the vehicle 1 according to the first embodiment.

As illustrated in FIG. 1, the vehicle 1 is provided with a brake pedal 111, a master cylinder 112, a brake pipe 113FL, a brake pipe 113RL, a brake pipe 113FR, a brake pipe 113RR, a front left wheel 121FL, a rear left wheel 121RL, a front right 121FR, a rear right 121RR, a wheel cylinder 122FL, a wheel cylinder 122RL, a wheel cylinder 122FR, a wheel cylinder 122RR, a brake actuator 13, a steering wheel 141, a vibration actuator 142, a vehicle speed sensor 151, a vehicle wheel speed sensor 152, a yaw rate sensor 153, an acceleration sensor 154, a camera 155, a display 161, a speaker 162, and an electronic control unit (ECU) 17, which is one specific example of the “lane departure suppressing apparatus”.

The brake pedal 111 is a pedal stepped by a driver to brake the vehicle 1. The master cylinder 112 is configured to adjust pressure of brake fluid (or any fluid) in the master cylinder 112 to pressure corresponding to a step amount of the brake pedal 111. The pressure of the brake fluid in the master cylinder 112 is transmitted to the wheel cylinders 122FL, 122RL, 122FR, and 122RR via the brake pipes 113FL, 113RL, 113FR, and 113RR, respectively. Thus, braking force corresponding to the pressure of the brake fluid transmitted to each of the wheel cylinders 122FL, 122RL, 122FR, and 122RR is applied to respective one of the front left wheel 121FL, the rear left wheel 121RL, the front right 121FR, and the rear right 121RR.

The brake actuator 13 is configured to adjust the pressure of the brake fluid transmitted to each of the wheel cylinders 122FL, 122RL, 122FR, and 122RR, independently of the step amount of the brake pedal 111, under control of the ECU 17. Therefore, the brake actuator 13 is configured to adjust the braking force applied to each of the front left wheel 121FL, the rear left wheel 121RL, the front right wheel 121FR, and the rear right wheel 121RR, independently of the step amount of the brake pedal 111.

The steering wheel 141 is an operator operated by the driver to steer the vehicle 1 (i.e. to steer vehicle wheels). In the embodiment, the steered wheels shall be the front left wheel 121FL and the front right wheel 121FR. The vibration actuator 142 is configured to vibrate the steering wheel 141, under the control of the ECU 17.

The vehicle speed sensor 151 is configured to detect a vehicle speed Vv of the vehicle 1. The vehicle wheel speed sensor 152 is configured to detect a vehicle wheel speed Vw of each of the front left wheel 121FL, the rear left wheel 121RL, the front right wheel 121FR, and the rear right wheel 121RR. The yaw rate sensor 153 is configured to detect a yaw rate y of the vehicle 1. The acceleration sensor 154 is configured to detect acceleration A (or specifically, longitudinal acceleration A1 and lateral acceleration A2) of the vehicle 1. The camera 155 is an imaging device configured to image an external situation ahead of the vehicle 1. Detection data indicating respective detection results of the vehicle speed sensor 151 to the acceleration sensor 154, and image data indicating images taken by the camera 155 are outputted to the ECU 17.

The display 161 is configured to display arbitrary information, under the control of the ECU 17. The speaker 162 is configured to output arbitrary audio, under the control of the ECU 17.

The ECU 17 is configured to control entire operation of the vehicle 1. Particularly in the embodiment, the ECU 17 is configured to perform a lane departure suppressing operation for suppressing departure or deviation of the vehicle 1 from a driving lane on which the vehicle 1 is currently traveling. Therefore, the ECU 17 functions as a control apparatus for realizing so-called lane departure alert (LDA) or lane departure prevention (LDP).

In order to perform the lane departure suppressing operation, the ECU 17 is provided with: a data acquirer 171; a LDA controller 172, which is one specific example of the “supporter”; an LDA adjuster 173, which is one specific example of the “controller”; and a margin calculator 174, which is one specific example of the “detector” and the “calculator”, as processing blocks logically realized or processing circuits physically realized inside the ECU 17. Operation of each of the data acquirer 171, the LDA controller 172, the LDA adjuster 173, and the margin calculator 174 will be detailed later, but its summary will be briefly explained hereinafter.

The data acquirer 171 is configured to obtain the detection data indicating the respective detection results of the vehicle speed sensor 151, the vehicle wheel speed sensor 152, the yaw rate sensor 153, and the acceleration sensor 154, and the image data indicating the images taken by the camera 155. The LDA controller 172 is configured to control the brake actuator 13 to apply to the vehicle 1 a suppression yaw moment by which the departure of the vehicle from the driving lane can be suppressed, by using the braking force applied to at least one of the front left wheel 121FL, the rear left wheel 121RL, the front right wheel 121FR, and the rear right wheel 121RR, if there is a possibility that the vehicle 1 departs or deviates from the driving lane on which the vehicle 1 is currently traveling, on the basis of the detection data and the image data obtained by the data acquirer 171. The expression “to suppress the departure of the vehicle 1 from the driving lane” in the embodiment means to reduce an actual departure distance of the vehicle 1 from the driving lane when the suppression yaw moment is applied, in comparison with a departure distance of the vehicle 1 from the driving lane when the suppression yaw moment is not applied. The LDA adjuster 173 is configured to adjust magnitude of the suppression yaw moment applied, by setting control intensity K of the lane departure suppressing operation. The margin calculator 174 is configured to calculate an avoidance margin width L, which is the width of an avoidance margin area 300, which exists around the vehicle 1.

(2) Avoidance Margin Area

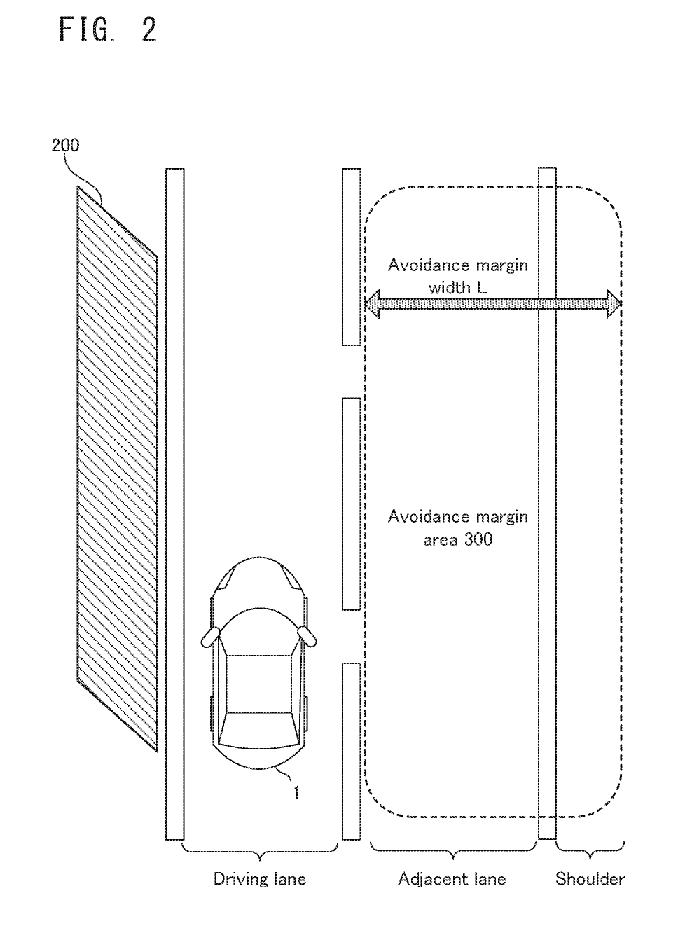

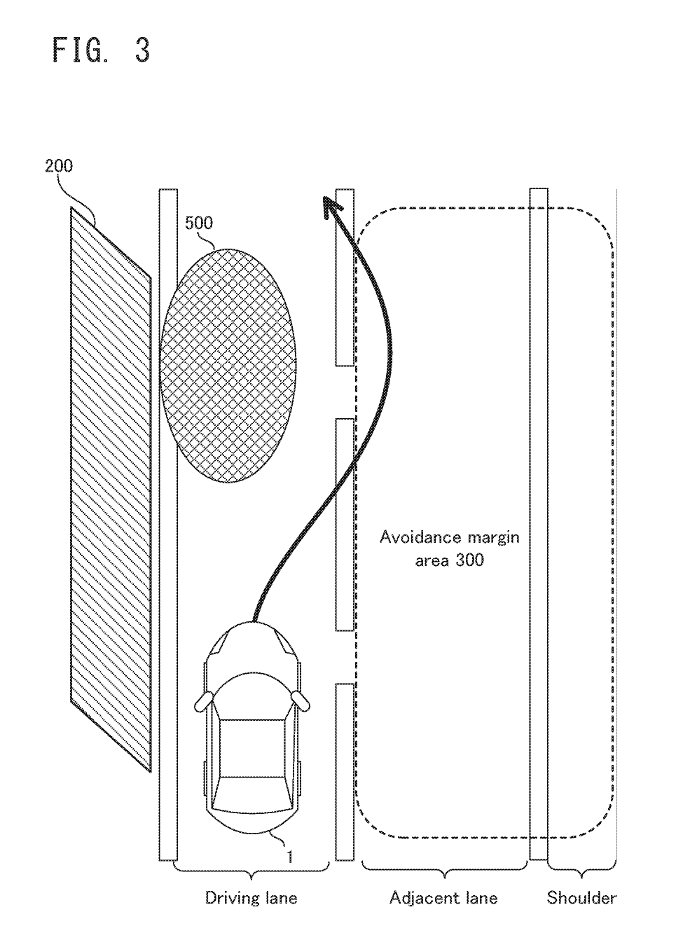

Next, the avoidance margin area 300 considered in the lane departure suppressing operation will be explained with reference to FIG. 2 and FIG. 3. FIG. 2 is a top view illustrating one example of the vehicle 1 that is traveling on a road and the avoidance margin area 300. FIG. 3 is a top view illustrating one example of an avoidance action when there is an obstacle ahead of the vehicle 1.

As illustrated in FIG. 2, the avoidance margin area 300 is an area adjacent to the driving lane on which the vehicle 1 is traveling, and is defined as an area in which the vehicle 1 can perform the avoidance action. In the example illustrated in FIG. 2, there is a wall 200 on the left side of the driving lane, and thus, the vehicle 1 cannot perform the avoidance action, which is to depart to the left side. Therefore, there is no avoidance margin area 300 on the left side of the driving lane. On the other hand, there are an adjacent lane and a shoulder on the right side of the driving lane, and the vehicle 1 can thus perform the avoidance action, which is to depart to the right side. Therefore, there is the avoidance margin area 300 with the avoidance margin width L corresponding to the adjacent lane and the shoulder, on the right side of the driving lane.

Although the shoulder is included in the avoidance margin area 300 here, the shoulder may not be included in the avoidance margin area 300. In other words, only the adjacent lane may be treated as the avoidance margin area 300 in an assumption that the avoidance action cannot be performed on the shoulder. Moreover, if it can be determined that the adjacent lane is an opposite lane, the adjacent lane may not be included in the avoidance margin area 300. This is because the avoidance action cannot be performed when there is an oncoming vehicle on the adjacent lane. Even if the adjacent lane is the opposite lane, the avoidance action can be performed if there is no oncoming vehicle. Thus, if the absence of the oncoming vehicle is confirmed even though it can be determined that the adjacent lane is the opposite lane, the adjacent lane may be included in the avoidance margin area 300.

As illustrated in FIG. 3, it is assumed that there is an obstacle 500 ahead of the vehicle 1. In this case, the vehicle 1 may perform the avoidance action along an arrow in the drawing. In other words, the vehicle 1 temporarily travels in the avoidance margin area 300, which exists on the right side of the driving lane, to avoid the obstacle 500.

In the vehicle 1 that performs the lane departure suppressing operation as in the embodiment, however, the suppression yaw moment for not allowing the vehicle 1 to depart from the lane even for the purpose of the aforementioned avoidance action is possibly applied. Specifically, even when an occupant of the vehicle 1 intentionally operates the vehicle 1 to travel in the avoidance margin area 300, there is a possibility that a strong suppression yaw moment is applied to return the vehicle 1 to the driving lane side. The lane departure suppressing operation of this type may give significant discomfort to the occupant of the vehicle.

The lane departure suppressing apparatus according to the embodiment is configured to appropriately perform the lane departure suppressing operation in view of the presence of the avoidance margin area 300, in order to avoid the aforementioned detrimental effect.

(3) Details of Lane Departure Suppressing Operation

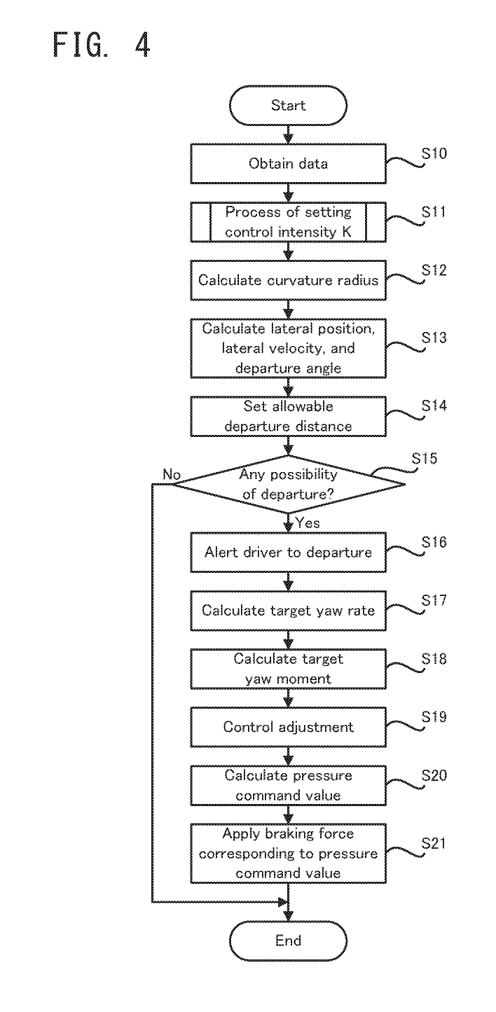

Next, the lane departure suppressing operation performed by the lane departure suppressing apparatus according to the embodiment (i.e. the ECU 17) will be explained in detail with reference to FIG. 4. FIG. 4 is a flowchart illustrating a flow of the lane departure suppressing operation according to the first embodiment.

As illustrated in FIG. 4, in the lane departure suppressing operation, the data acquirer 171 obtains the detection data indicating respective detection results of the vehicle speed sensor 151, the vehicle wheel speed sensor 152, the yaw rate sensor 153, and the acceleration sensor 154, and the image data indicating images taken by the camera 155 (step S10).

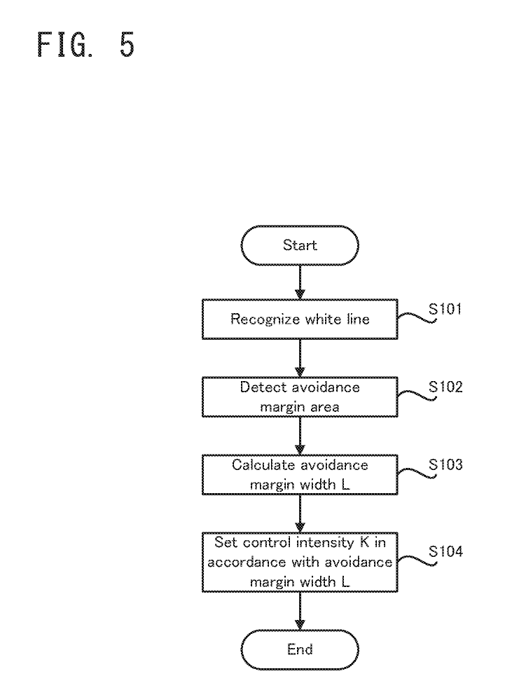

Then, the margin calculator 174 analyzes the image data obtained in the step S10, thereby performing a process of setting the control intensity K of the lane departure suppressing operation (step S11). The control intensity K is one specific example of the “intensity of the departure suppression support”. The process of setting the control intensity K, which will be explained later in detail with reference to FIG. 5, includes a process of recognizing a white line to be used for the subsequent process.

After the control intensity K is set, the LDA controller 172 calculates a curvature radius R of the driving lane on which the vehicle 1 is currently traveling, on the basis of the white line specified in the step S11 (step S12). The curvature radius R of the driving lane is substantially equivalent to a curvature radius of the white line. Thus, the LDA controller 172 may calculate the curvature radius of the white line specified in the step S11 and may treat the calculated curvature radius as the curvature radius R of the driving lane. The LDA controller 172 may use position information about a position of the vehicle 1 specified by using a global positioning system (GPS) and map information used for a navigation operation, thereby calculate the curvature radius R of the driving lane on which the vehicle 1 is currently traveling.

The LDA controller 172 further calculates a current lateral position X of the vehicle 1, on the basis of the white line specified in the step S11 (step S13). Here, the “lateral position X” in the embodiment indicates a distance from the center of the driving lane to the vehicle 1 (or typically a distance to the center of the vehicle 1) in a lane width direction orthogonal to a direction in which the driving lane extends (or a lane extension direction). In this case, one of a direction directed from the center of the driving lane to the right side and a direction directed to the left side is preferably set as a positive direction, and the other direction is preferably set as a negative direction. The same shall apply to a lateral velocity Vl described later, a yaw moment such as the aforementioned suppression yaw moment, the aforementioned acceleration A, the aforementioned yaw rate y, and the like.

The LDA controller 172 further calculates a departure angle θ of the vehicle 1, on the basis of the white line specified in the step S11 (the step S13). The “departure angle θ” in the embodiment indicates an angle between the driving lane and a longitudinal direction axis of the vehicle 1 (i.e. an angle between the white line and the longitudinal direction axis of the vehicle 1).

The LDA controller 172 further calculates the lateral velocity Vl of the vehicle 1, on the basis of time-series data of the lateral position X of the vehicle 1 calculated from the white line (the step S13). The LDA controller 172 may calculate the lateral velocity Vl of the vehicle 1, on the basis of at least one of the detection result, the calculated departure angle θ, and the detection result of the acceleration sensor 154. The “lateral velocity Vl” in the embodiment indicates a velocity or speed of the vehicle 1 in the lane width direction.

The LDA controller 172 further sets an allowable departure distance D (step S14). The allowable departure distance D indicates an allowable maximum value of the departure distance of the vehicle 1 from the driving lane (i.e. the departure distance of the vehicle 1 from the white line) when the vehicle 1 departs from the driving lane. Thus, the lane departure suppressing operation is an operation of applying the suppression yaw moment to the vehicle 1 in such a manner that the departure distance of the vehicle 1 from the driving lane is within the allowable departure distance D.

The LDA controller 172 may set the allowable departure distance D from the viewpoint of satisfying requirements of law and regulations (e.g. requirements of new car assessment programme (NCAP)). In this case, the allowable departure distance D set from the viewpoint of satisfying the requirements of law and regulations may be used as the allowable departure distance D by default.

If the departure angle θ is relatively large, the departure distance of the vehicle 1 when the vehicle 1 departs from the driving lane is highly likely larger than that if the departure angle θ is relatively small. In the same manner, if the lateral velocity Vl is relatively large, the departure distance of the vehicle 1 when the vehicle 1 departs from the driving lane is highly likely larger than that if the lateral velocity Vl is relatively small. In other words, if at least one of the departure angle θ and the lateral velocity Vl is relatively large, the suppression yaw moment applied to the vehicle 1 to include the departure distance of the vehicle 1 within the allowable departure distance D is highly likely larger than that if at least one of the departure angle θ and the lateral velocity Vl is relatively small. On the other hand, the application of an excessive suppression yaw moment may unstabilize behavior of the vehicle 1. Thus, the LDA controller 172 may set the allowable departure distance D (or may adjust the allowable departure distance D by default), on the basis of at least one of the departure angle θand the lateral velocity Vl calculated in the step S13. For example, the LDA controller 172 may set or adjust the allowable departure distance D in such a manner that the allowable departure distance D increases as at least one of the departure angle θ and the lateral velocity Vl increases.

Then, the LDA controller 172 determines whether or not there is a possibility that the vehicle 1 departs from the driving lane on which the vehicle 1 is currently traveling (step S15). Specifically, the LDA controller 172 may calculate a future lateral position Xf. For example, the LDA controller 172 may calculate the lateral position X when the vehicle 1 has traveled a distance corresponding to a forward gazing distance from a current position, as the future lateral position Xf. The future lateral position Xf can be calculated by adding or subtracting a multiplication value between the lateral vehicle Vl and a time Δt, which is required for the vehicle 1 to travel the forward gazing distance, to or from the current lateral position X. Then, the LDA controller 172 may determine whether or not an absolute value of the future lateral position Xf is greater than or equal to a departure threshold value. If the vehicle 1 faces in a direction parallel to the lane extension direction, the departure threshold value is a value determined on the basis of, for example, the width of the driving lane and the width of the vehicle 1 (which is specifically (width of driving lane—width of vehicle 1)/2). In this case, a situation in which the absolute value of the future lateral position Xf is equal to the departure threshold value corresponds to a situation in which a side of the vehicle 1 in the lane width direction (e.g. a side that is farther from the center of the driving lane) is positioned on the white line. A situation in which the absolute value of the future lateral position Xf is greater than the departure threshold value corresponds to a situation in which the side of the vehicle 1 in the lane width direction (e.g. the side that is farther from the center of the driving lane) is located outside the white line. Thus, if the absolute value of the future lateral position Xf is not greater than or equal to the departure threshold value, the LDA controller 172 may determine that there is no possibility that the vehicle 1 departs from the driving lane on which the vehicle 1 is currently traveling. In reality, however, the vehicle 1 faces in the direction parallel to the lane extension direction in some cases. Thus, an arbitrary value that is different from the value in the aforementioned example may be used as the departure threshold value.

The operation explained here is merely one example of the operation of determining whether or not there is a possibility that the vehicle 1 departs from the driving lane on which the vehicle 1 is currently traveling. Therefore, the LDA controller 172 may use an arbitrary determination criterion, thereby determining whether or not there is a possibility that the vehicle 1 departs from the driving lane on which the vehicle 1 is currently traveling. One example of the situation in which “there is a possibility that the vehicle 1 departs from the driving lane” is a situation in which the vehicle 1 goes across or is on the white line in a near future (e.g. at a point at which the vehicle 1 has traveled the distance corresponding to the forward gazing distance described above).

As a result of the determination in the step S15, if it is determined that there is no possibility that the vehicle 1 departs from the driving lane (the step S15: No), the lane departure suppressing operation is ended. Therefore, operation steps performed when it is determined that there is no possibility that the vehicle 1 departs from the driving lane (i.e. step S16 to step S21) are not performed. In other words, the LDA controller 172 controls the brake actuator 13 not to apply the suppression yaw moment to the vehicle 1 (i.e. not to apply the braking force that allows the suppression yaw moment to be applied to the vehicle 1). Moreover, the LDA controller 172 does not alert the driver to the possibility of the departure of the vehicle 1 from the driving lane.

If the lane departure suppressing operation is ended due to the determination that there is no possibility that the vehicle 1 departs from the driving lane, the ECU 17 may start the lane departure suppressing operation again from the step S10 after a lapse of a first predetermined period (e.g. several to several ten milliseconds). In other words, the lane departure suppressing operation is repeatedly performed with a period corresponding to the first predetermined period. The first predetermined period corresponds to a default period in which the lane departure suppressing operation is repeatedly performed.

On the other hand, as a result of the determination in the step S15, if it is determined that there is a possibility that the vehicle 1 departs from the driving lane (the step S15: Yes), the LDA controller 172 alerts the driver to the possibility of the departure of the vehicle 1 from the driving lane (step S16). For example, the LDA controller 172 may control the display 161 to display images indicating the possibility of the departure of the vehicle 1 from the driving lane. Alternatively, for example, in addition to or instead of controlling the display 161 as described above, the LDA controller 172 may control the vibration actuator 142 to inform the driver of the possibility of the departure of the vehicle 1 from the driving lane by using the vibration of the steering wheel 141. Alternatively, for example, in addition to or instead of controlling at least one of the display 161 and the vibration actuator 142 as described above, the LDA controller 172 may control the speaker (or so-called buzzer) 162 to inform the driver of the possibility of the departure of the vehicle 1 from the driving lane by using an alarm or a warning sound.

If it is determined that there is a possibility that the vehicle 1 departs from the driving lane, the LDA controller 172 further controls the brake actuator 13 to apply the braking force that allows the suppression yaw moment to be applied to the vehicle 1 (step S17 to step S21).

Specifically, if there is a possibility that the vehicle 1 departs from the driving lane, the vehicle 1 highly likely travels in a manner of moving away from the center of the driving lane. Thus, if a travel trajectory of the vehicle 1 is changed from a travel trajectory in which the vehicle 1 moves away from the center of the driving lane to a travel trajectory in which the vehicle 1 moves toward the center of the driving lane, the departure of the vehicle 1 from the driving lane is suppressed. For this, the LDA controller 172 may calculate a new travel trajectory in which the vehicle 1 that has moved away from the center of the driving lane moves toward the center of the driving lane, on the basis of the detection data, the image data, the specified white line, the calculated curvature radius R, the calculated lateral position X, the calculated lateral velocity Vl, the calculated departure angle θ, and the set allowable departure distance D. At this time, the LDA controller 172 may calculate a new travel trajectory that satisfies the restriction of the allowable departure distance D set in the step S14. Moreover, the LDA controller 172 calculates the yaw rate estimated to be generated on the vehicle 1 that travels the calculated new travel trajectory, as a target yaw rate y_{tgt} (step S17).

Then, the LDA controller 172 calculates the yaw moment to be applied to the vehicle 1 in order to generate the target yaw rate y_{tgt} on the vehicle 1, as a target yaw moment M_{tgt} (step S18). The target yaw moment M_{tgt} is equivalent to the suppression yaw moment.

Here, particularly in the embodiment, the LDA adjuster 173 performs a process of adjusting the target yaw moment M_{tgt}, which is to be applied by the LDA controller 172 (step S19). Specifically, the LDA adjuster 173 may multiply the target yaw moment M_{tgt} by the control intensity K, thereby calculating an adjusted target yaw moment M_{tgt2}. Thus, the calculated adjusted target yaw moment M_{tgt2} has a smaller value as the control intensity K is reduced. The control intensity K is a value set in a range of 0≤K≤1. Thus, the calculated adjusted target yaw moment M_{tgt2} has the same value as or a less value than that of the target yaw moment M_{tgt}.

Then, the LDA controller 172 calculates the braking force that allows the adjusted target yaw moment M_{tgt2} to be applied to the vehicle 1. In this case, the LDA controller 172 may individually calculate the braking force applied to each of the front left wheel 121FL, the rear left wheel 121RL, the front right wheel 121FR, and the rear right wheel 121RR. Then, the LDA controller 172 calculates a pressure command value for specifying the pressure of the brake fluid required to generate the calculated braking force (step S20). In this case, the LDA controller 172 may individually calculate the pressure command value for specifying the pressure of the brake fluid inside each of the wheel cylinders 122FL, 122RL, 122FR, and 122RR.

For example, if it is determined that there is a possibility that the vehicle 1 goes across the white line located on the right side with respect to a moving direction of the vehicle 1 and departs from the driving lane, the suppression yaw moment that can deflect the vehicle 1 to the left side with respect to the moving direction of the vehicle 1 may be applied to the vehicle 1 in order to suppress the departure of the vehicle 1 from the driving lane. In this case, if the braking force is not applied to the front right wheel 121FR and the rear right wheel 121RR but the braking force is applied to at least one of the front left wheel 121FL and the rear left wheel 121RL, or if the braking force that is relatively small is applied to at least one of the front right wheel 121FR and the rear right wheel 121RR and the braking force that is relatively large is applied to at least one of the front left wheel 121FL and the rear left wheel 121RL, then, the suppression yaw moment that can deflect the vehicle 1 to the left side is applied to the vehicle 1. On the other hand, if it is determined that there is a possibility that the vehicle 1 goes across the white line located on the left side with respect to the moving direction of the vehicle 1 and departs from the driving lane, the suppression yaw moment that can deflect the vehicle 1 to the right side with respect to the moving direction of the vehicle 1 may be applied to the vehicle 1 as long as the braking force is not applied to the front left wheel 121FL and the rear left wheel 121RL but the braking force is applied to at least one of the front right wheel 121FR and the rear right wheel 121RR, or as long as the braking force that is relatively small is applied to at least one of the front left wheel 121FL and the rear left wheel 121RL and the braking force that is relatively large is applied to at least one of the front right wheel 121FR and the rear right wheel 121RR.

Then, the LDA controller 172 controls the brake actuator 13, on the basis of the pressure command value calculated in the step S20. Therefore, the braking force corresponding to the pressure command value is applied to at least one of the front left wheel 121FL, the rear left wheel 121RL, the front right wheel 121FR, and the rear right wheel 121RR (step S21). As a result, the suppression yaw moment equivalent to the adjusted target yaw moment M_{tgt2} is applied to the vehicle 1, by which the departure of the vehicle 1 from the driving lane is suppressed.

(4) Details of Processing of Setting Control Intensity K

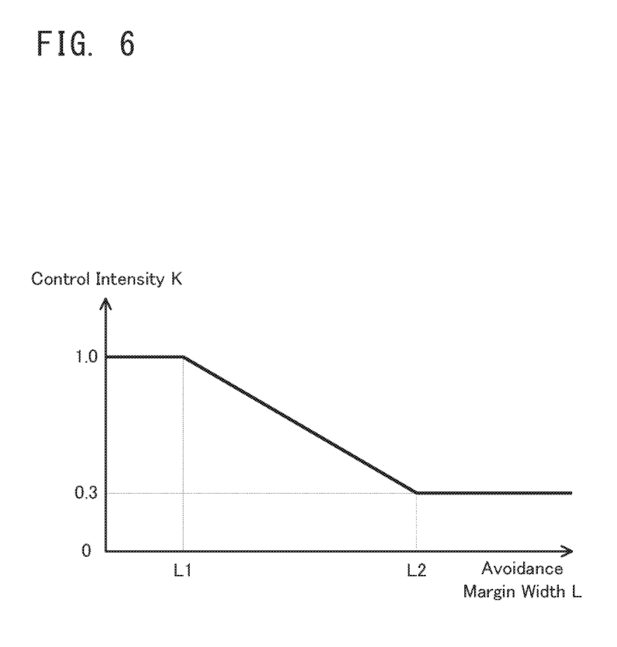

Next, the process of setting the control intensity K in the aforementioned lane departure suppressing operation (i.e. the step S11 in FIG. 4) will be explained in detail with reference to FIG. 5 and FIG. 6. FIG. 5 is a flowchart illustrating a flow of the process of setting the control intensity K according to the first embodiment. FIG. 6 is a map illustrating a relation between the avoidance margin width L and the control intensity K.

As illustrated in FIG. 5, after the start of the process of setting the control intensity K, the margin calculator 174 analyzes the image data obtained in the step S10, thereby recognizes the white line for defining the driving lane on which the vehicle 1 is currently traveling (step S101). In other words, the margin calculator 174 may specify a position of the white line, which is drawn on the road on which the vehicle 1 is traveling, in the image taken by the camera 155. Moreover, the margin calculator 174 may recognize another white line if there is another white line other than the white line for specifying the driving lane (e.g. if there is the adjacent lane). The white line is recognized as one example of a lane edge, but something other than the white line may be recognized as the lane edge.

Then, the margin calculator 174 detects the avoidance margin area 300 located outside the recognized white line (or specifically, the white line for specifying the driving lane on which the vehicle 1 is currently traveling) (step S102). The margin calculator 174 separately detects the avoidance margin area 300 located on the right side viewed from the vehicle 1, and the avoidance margin area 300 located on the left side viewed from the vehicle 1. The avoidance margin area 300 may be detected, for example, as an area between the white line for defining another lane and an obstacle (in other words, a road edge), out of the area located outside the white line for defining the driving lane, as viewed from the vehicle 1.

The avoidance margin area 300 is an area in which the vehicle can perform the avoidance action, and is thus preferably an area with a sufficiently ensured length in the lane extension direction (i.e. the moving direction of the vehicle). Thus, an area in which the length in the lane extension direction does not satisfy a safety stop distance, which is determined in accordance with, for example, the vehicle speed of the vehicle 1 or the like, may not be detected as the avoidance margin area 300.

Then, the margin calculator 174 calculates the avoidance margin width L, which is the width of the avoidance margin area 300 (step S102). The avoidance margin width L is calculated as a width in the lane width direction orthogonal to the lane extension direction of the avoidance margin area 300.

Then, the margin calculator 174 sets the control intensity K in accordance with the avoidance margin width L (step S104). The margin calculator 174 may set the control intensity K to be smaller as the avoidance margin width L becomes larger.

As illustrated in FIG. 6, the margin calculator 174 may store therein, for example, a map illustrating the relation between the avoidance margin width L and the control intensity K, and may determine a value of the control intensity K corresponding to the avoidance margin width L. In the example illustrated in FIG. 6, the control intensity K is determined to be 1.0 if the avoidance margin width L is less than or equal to a predetermined value L1. Moreover, the control intensity K is determined to be gradually increased if the avoidance margin width L is greater than the predetermined value L1 and is less than or equal to a predetermined value L2. Moreover, the control intensity K is determined to be 0.3 if the avoidance margin width L is greater than the predetermined value L2. The predetermined value L1 is set as a value corresponding to a width in which the vehicle 1 hardly performs the avoidance action. The predetermined value L2 is set as a value corresponding to a width in which the vehicle 1 can perform the avoidance action with a sufficient margin and does not require an extra area.

The aforementioned method of setting the control intensity K is merely one example. The control intensity K may be set in another method as long as the control intensity K is reduced in accordance with the avoidance margin width L. The minimum value of the control intensity K of 0.3 can be also arbitrarily set. For example, if the minimum value of the control intensity K is set to be about 0.8, which is relatively large, the lane departure suppressing operation is hardly limited in comparison with the case of the minimum value of 0.3 (in other words, the adjusted target yaw moment M_{tgt2} is hardly limited to be small). Alternatively, if the minimum value of the control intensity K is set to 0 and if the avoidance margin L is sufficiently large, the lane departure suppressing operation can be stopped.

By setting the control intensity K in this manner, the adjusted target yaw moment M_{tgt2} that is relatively large is applied to the vehicle 1 if the avoidance margin width L is relatively small and if there is a possibility that the vehicle 1 departs from the lane. It is thus possible to certainly prevent the lane departure of the vehicle 1. On the other hand, the adjusted target yaw moment M_{tgt2} that is relatively small is applied to the vehicle 1 if the avoidance margin width L is relatively large and if there is a possibility that the vehicle 1 departs from the lane. It is thus possible to prevent that an inappropriate yaw moment (in other words, braking force) is applied to the vehicle 1 that is about to perform the avoidance action and that discomfort is given to the occupant of the vehicle 1. It is also possible to call the occupant's attention to the lane departure by applying to the vehicle 1 the minimum yaw moment that does not prevent the avoidance action.

The use of the avoidance margin width L as in the embodiment allows accurate determination of the situation around the vehicle and appropriate implementation of the lane departure suppressing operation, for example, even when a line type of the white line cannot be recognized.

### Second Embodiment

Next, a lane departure suppressing apparatus according to a second embodiment will be explained. The second embodiment is partially different from the first embodiment in the process of setting the control intensity K, and the other operation and apparatus configuration are substantially the same. Thus, hereinafter, a different part from that of the first embodiment explained above will be explained in detail, and an explanation of the same part will be omitted.

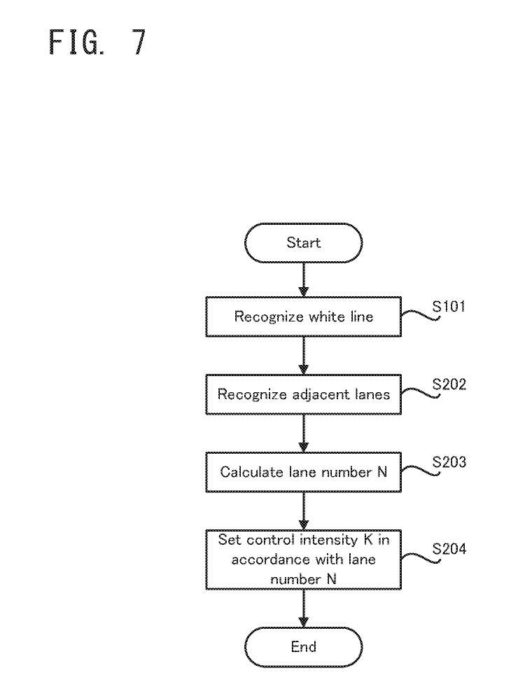

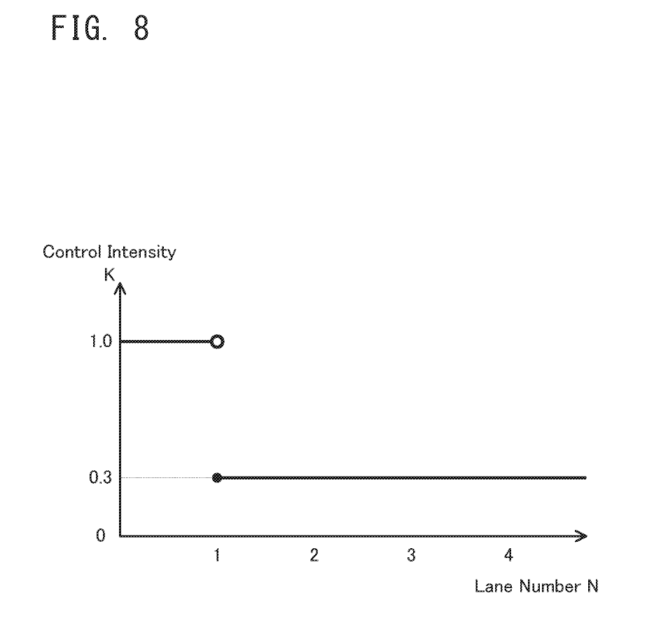

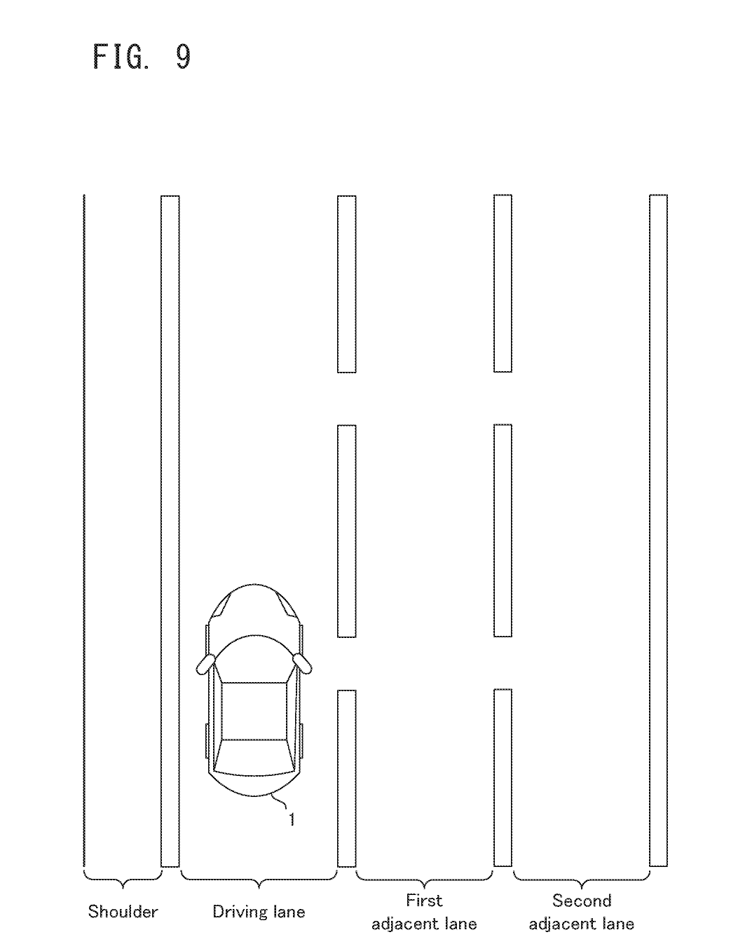

The process of setting the control intensity K according to the second embodiment will be explained with reference to FIG. 7 to FIG. 9. FIG. 7 is a flowchart illustrating a flow of the process of setting the control intensity K according to the second embodiment. FIG. 8 is a map illustrating a relation between a number N of lanes and the control intensity K. FIG. 9 is a top view illustrating one example of a vehicle that is traveling on a road and adjacent lanes. FIG. 7 carries the same step number for the same process step explained by using FIG. 5.

As illustrated in FIG. 7, after the start of the process of setting the control intensity K, the margin calculator 174 recognizes the white line that exists around the vehicle 1 (the step S101).

Then, the margin calculator 174 recognizes the adjacent lanes adjacent to the driving lane on which the vehicle 1 is traveling, on the basis of the recognized white line (step S202). The “adjacent lanes” recognized here are not only lanes adjacent to the driving lane, but also conceptually include all the lanes other than the driving lane. In other words, not only the lanes next to the driving lane but also other lanes next to the relevant next lanes are recognized as the adjacent lanes.

Then, the margin calculator 174 calculates a lane number N, which is the number of the recognized adjacent lanes (step S203). The lane number N is calculated separately for the right side and the left side of the vehicle 1. The lane number N herein is calculated as what corresponds to the avoidance margin width L in the embodiment (i.e. the width of the avoidance margin area 300 that allows the avoidance action). Thus, an adjacent lane on which the avoidance action cannot be performed due to the presence of another vehicle or for similar reasons may not be counted in the lane number N.

Then, the margin calculator 174 sets the control intensity K in accordance with the lane number N (step S204). The margin calculator 174 may set the control intensity K to be smaller as the lane number N becomes larger.

As illustrated in FIG. 8, the margin calculator 174 may store therein, for example, a map illustrating the relation between the lane number N and the control intensity K, and may determine the value of the control intensity K corresponding to the lane number N. In the example illustrated in FIG. 8, the control intensity K is determined to be 1.0 if the lane number is less than 1 (i.e. if there is no adjacent lane). On the other hand, the control intensity K is determined to be 0.3 if the lane number N is greater than or equal to 1 (i.e. if there is the adjacent lane). Here, the control intensity K is determined in a binary manner. As illustrated in FIG. 6, however, the control intensity K may be changed in a linear or stepwise manner in accordance with the lane number N.

As illustrated in FIG. 9, it is assumed, for example, that there are a shoulder on the left side of the vehicle 1, a first adjacent lane on the right side of the vehicle 1, and a second adjacent lane next to the first adjacent lane. In this case, the lane number N on the left side of the vehicle 1 is 0 (i.e. less than 1), and the control intensity K is thus 1.0. In other words, the shoulder is treated as an area in which the avoidance action cannot be performed, and if the vehicle 1 is about to depart to the left side, the suppression yaw moment that is large is applied. On the other hand, the lane number N on the right side of the vehicle 1 is 2 (i.e. greater than or equal to 1), and the control intensity K is thus 0.3. In other words, it is determined that there is a sufficient area in which the vehicle 1 performs the avoidance action, and if the vehicle 1 is about to depart to the right side, only the suppression yaw moment that is small is applied.

By setting the control intensity K in accordance with the lane number N as described above, intensity of the suppression yaw moment (i.e. intensity or extent of the lane departure suppressing operation) can be adjusted more simply than in the first embodiment in which the avoidance margin width L is used. Specifically, the control intensity K can be set by recognizing the white line and calculating the lane number N without accurately calculating a value indicating the avoidance margin width L or the like. Moreover, the use of the lane number N allows determination based on the “lane width”, which is one example of a width required for the traveling (i.e. the avoidance action) of the vehicle 1. For example, if the lane number N is 1, it can be determined that the avoidance margin area 300 has a width corresponding to at least one lane width. If the lane number N is 0, it can be determined that the avoidance margin area 300 has a width that is less than one lane width. It is thus possible to appropriately set the control intensity K without calculating the value indicating a specific width, such as the avoidance margin width L.

### Third Embodiment

Next, a lane departure suppressing apparatus according to a third embodiment will be explained. The third embodiment is partially different from the first and second embodiments in the process of setting the control intensity K, and the other operation and apparatus configuration are substantially the same. Thus, hereinafter, a different part from those of the first and second embodiments explained above will be explained in detail, and an explanation of the same part will be omitted.

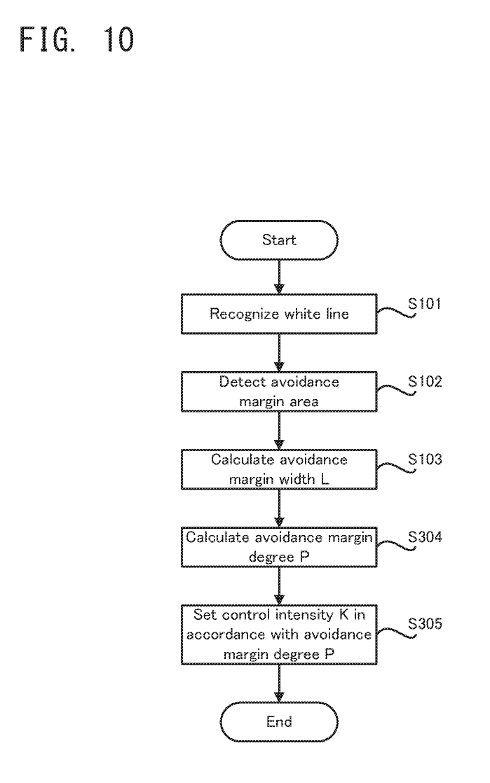

The process of setting the control intensity K according to the third embodiment will be explained with reference to FIG. 10. FIG. 10 is a flowchart illustrating a flow of the process of setting the control intensity K according to the third embodiment. FIG. 10 carries the same step number for the same process step explained by using FIG. 5.

As illustrated in FIG. 10, after the start of the process of setting the control intensity K, the margin calculator 174 recognizes the white line that exists around the vehicle 1 (the step S101), detects the avoidance margin area 300 (the step S102), and calculates the avoidance margin width L (the step S103).

Then, the margin calculator 174 calculates an avoidance margin degree P by dividing the avoidance margin width L by a predetermined width Li (step S304). The “predetermined width Li” is set as a value corresponding to the width of the lane on which the vehicle 1 is traveling, or the width of a general lane. Thus, the avoidance margin degree P, which is obtained by dividing the avoidance margin width L by the predetermined width Li, has a value substantially close to the lane number N in the second embodiment.

Then, the margin calculator 174 sets the control intensity K in accordance with the avoidance margin degree P (step S305). The margin calculator 174 sets the control intensity K to be smaller as the avoidance margin degree P becomes larger. The control intensity K may be set, for example, by using the map as illustrated in FIG. 6 and FIG. 8.

As explained above, the avoidance margin degree P is calculated as a value substantially close to the lane number N in the second embodiment. It is thus possible to perform appropriate lane departure suppression control by setting the control intensity K as in the second embodiment. Moreover, even if the white line for calculating the lane number N cannot be normally recognized, the value close to the lane number N can be obtained by calculating the avoidance margin degree P. For example, it is assumed that the white line other than the white line for defining the driving lane on which the vehicle 1 is traveling can be recognized, but the other white lines cannot be recognized. Even in this case, if the road edge can be detected on the basis of the presence of an obstacle or the like, the avoidance margin width L can be calculated by detecting the avoidance margin area 300 from the detected road edge, and the avoidance margin degree P corresponding to the lane number N can be calculated, by which the control intensity K can be appropriately set.

As explained above, according to the lane departure suppressing apparatuses in the first to third embodiments, the control intensity K is set by using the avoidance margin width L, the lane number N, or the avoidance margin degree P. As a result, it is possible to appropriately perform the lane departure suppressing operation in accordance with the situation around the vehicle.

In the first to third embodiments, the vehicle 1 that performs so-called brake LDA as the lane departure suppressing operation is explained as an example; however, the vehicle 1 that can perform another control (e.g. EPS-LDA) can also obtain the same technical effects. In other words, the lane departure suppressing operation is not particularly limited but may be arbitrary as long as it can suppress the departure of the vehicle 1 from the lane.

The invention may be embodied in other specific forms without departing from the spirit or essential characteristics thereof. The present embodiments and examples are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A lane departure suppressing apparatus comprising:
a supporter configured to perform departure suppression support for suppressing departure of a vehicle from a driving lane on which the vehicle is currently traveling;
a detector configured to detect an adjacent area adjacent to the driving lane;
a calculator configured to calculate an adjacent margin width, which is width of an area in which the vehicle can perform an avoidance action, out of the adjacent area; and
a controller configured to control said supporter to increase intensity of the departure suppression support as the avoidance margin width becomes smaller.

2. The lane departure suppressing apparatus according to claim 1, wherein
said calculator is configured to calculate a number of lanes that exist in the adjacent area, instead of the avoidance margin width, and
said controller is configured to control said supporter to increase the intensity of the departure suppression support as the number of the lanes becomes smaller.

3. The lane departure suppressing apparatus according to claim 1, wherein
said calculator is configured to calculate an avoidance margin degree by dividing the avoidance margin width by a predetermined width, and
said controller is configured to control said supporter to increase the intensity of the departure suppression support as the avoidance margin degree becomes smaller, instead of the avoidance margin width.

4. The lane departure suppressing apparatus according to claim 1, wherein said supporter is configured to perform the departure suppression support (i) by calculating a suppression yaw moment, which allows the departure of the vehicle from the driving lane, and (ii) by applying braking force to wheels in such a manner that the calculated suppression yaw moment is applied to the vehicle, if there is a possibility that the vehicle departs from the driving lane.
